(19) United States
(12) Patent Application Publication
(10) Pub. No.: US 2003/0103792 A1
(43) Pub. Date: Jun. 5, 2003

(54) Image-recording device

(75) Inventor: Noboru Endo, Kanagawa (JP)

Correspondence Address: MORGAN LEWIS & BOCKIUS LLP, 1111 PENNSYLVANIA AVENUE NW, WASHINGTON, DC, 20004, US

(73) Assignee: FUJI XEROX CO., LTD.

(21) Appl. No.: 10/230,380

(22) Filed: Aug. 29, 2002

(30) Foreign Application Priority Data
Nov. 30, 2001 (JP) 2001-367564

(51) Int. Cl. B41J 13/00

(52) U.S. Cl. 400/578

(57) ABSTRACT

An image-recording device including a pair of rollers on a side of a recording region at which a recording sheet is supplied thereto and a pair of rollers on a side of the recording region at which the recording sheet is ejected therefrom. The recording sheet is nipped between the rollers and is thereby conveyed. The roller arranged to be in contact with the recording sheet on a side opposite to a surface thereof on which an image is formed has a rigid body including a metal material and having a cylindrical surface. The surface of the roller is subjected to ceramic or urethane coating to generate a friction force, required for conveyance of the recording sheet, between the surface and the recording sheet, which passes between the roller and a roller arranged opposite to the roller.

### BACKGROUND OF THE INVENTION

1. Field of the Invention

The present invention relates to an image-recording device, and more particularly to an image-recording device that conveys an image recording sheet and performs image recording on a surface of the sheet.

2. Description of the Related Art

Conventionally, in an image-recording device such as, for example, an inkjet recording device, image recording has been carried out by conveying paper for recording (a recording sheet) in a certain direction while discharging ink drops onto the recording paper in accordance with image information (image data). That is, an inkjet recording head is operated to move in a direction intersecting the conveyance direction of the recording paper while discharging the ink drops (main scanning), and is repeatedly reciprocated as the recording paper is conveyed (sub-scanning). Thus, an image is recorded on the recording paper. Accordingly, in order to record images at higher image quality, improvements in accuracy of conveyance of the recording paper are required.

As a method for improving the accuracy of conveyance of a recording sheet, for example, the method described in Japanese Patent Publication No. 2962948 is known. In this method, in order to convey a recording sheet over a desired conveyance distance, the numbers of drive pulses for respective lines in an initial state are increased or decreased, and the numbers of pulses are stored in a memory as the numbers of pulses of the lines. On the basis of the stored information (the numbers of drive pulses), the conveyance of the recording sheet is controlled.

However, according to this method, in the process for manufacturing an image-recording device, a conveyance distance must be adjusted by printing an image pattern. When the diameter of a supply roller changes due to a change in temperature, abrasion, or the like, the conveyance distance also changes with the change in diameter. Accordingly, the conveyance distance cannot be made constant corresponding to the change in conveyance distance.

In contrast to this, as a configuration which improves the accuracy of conveyance of the rear end portion of a recording sheet and which avoids a conveyance distance from being changed by a change in temperature or the like, there is a printer described in Japanese Patent Application Laid-Open (JP-A) No. 10-167507. In the configuration of the printer, an ejection roller comprises a material such as a metal having high rigidity, and a spur (star wheel) is formed on the roller. A trench is formed in a circumferential direction on a roller facing the ejection roller at a position opposing the spur.

In general, an ejection roller frequently consists of a material having elasticity such as rubber. In contrast with the rubber ejection roller, the ejection roller in the configuration described in JP-A No. 10-167507 has no elasticity. For this reason, this configuration cannot easily obtain a desired conveying force.

In order to increase the conveying force, for example, the number of spurs may be increased, or a pressure of the spur on the recording sheet may be set to be high.

However, when the number of spurs is increased, the number of parts increases, and a large number of steps for treating the ejection roller is required. As a result, costs increase.

When the pressure on the spur is increased, there is a greater possibility that a so-called spur mark (a stain generated when undried ink on the recording sheet is transferred to the spur and retransferred to the recording sheet) conspicuously occurs.

### SUMMARY OF THE INVENTION

The present invention has been achieved in consideration of the above circumstances, and has as an object thereof to provide an image-recording device, which can record a high-quality image by conveying a recording sheet with high accuracy without being influenced by a change in temperature or the like and which can be produced at a low cost.

According to an aspect of the invention, there is provided a device for recording an image on a recording sheet, the device comprising: image recording means including a recording region for recording an image on a recording sheet conveyed to the recording region; sheet supply means for supplying the recording sheet to the recording region; and sheet ejecting means for ejecting the recording sheet from the recording region, wherein at least one of the sheet supply means and the sheet ejecting means includes, a first roller arranged for contacting the recording sheet on a surface on which an image is formed by the image recording means; and a second roller arranged in opposition to the first roller and with the rollers nipping the recording sheet when the recording sheet passes between the rollers, and the second roller comprising a rigid body and a surface treated to generate a friction force between the second roller and the recording sheet when passing between the rollers for conveyance of the recording sheet.

In the aspect of the invention, the sheet ejecting means may include said rollers.

That is, in this image-recording device, the image-recording means records an image on the recording sheet that has been supplied to the image recording region by the supply means. Thereafter, the ejection means ejects the recording sheet from the image recording region.

In the image-recording device according to the invention, the sheet ejecting means, as will be described below in the embodiments, has an ejection roller functioning as the second roller and facing ejection roller functioning as the first roller, and the recording sheet is nipped by the first roller and the second roller so as to be conveyed.

Since the ejection roller comprises a rigid body, the ejection roller does not change in shape, and an amount of change in shape (in particular, diameter) of the ejection roller due to a change in temperature or the like is small. Therefore, the change of a conveyance distance of the recording sheet decreases.

A surface of the ejection roller is treated such that a desired friction force is generated between the surface and the recording sheet. Therefore, a required conveying force can be obtained while the recording sheet is nipped between the ejection roller and the facing ejection roller, and the recording sheet can be conveyed with high accuracy.

Furthermore, the ejection roller and the facing ejection rollers (sheet ejecting means) constituted to generate a desired conveying force as described above are arranged on an ejecting side of the recording sheet, i.e., a downstream side in the conveyance direction with respect to the image recording means. Therefore, even when a portion near the rear end of the recording sheet is released from the sheet supply means, the recording sheet can be reliably conveyed with high accuracy. For this reason, a high-quality image can be recorded on the recording sheet.

The ejection roller contacts the recording sheet on an opposite surface from an image recording surface on which the image recording means records an image. Therefore, recording material (e.g., ink) on the recording sheet is not transferred to the ejection roller. In addition, the facing ejection rollers also nip the recording sheet at both the sides in the conveyance direction of the recording sheet, i.e., both width direction end portions of the recording sheet. In general, an image is not recorded on the recording sheet at portions near both width direction ends of the recording sheet. For this reason, recording material that forms the recorded image is not transferred to the facing ejection rollers. In this manner, the recording material can be prevented from being re-transferred to the recording sheet.

Furthermore, a member corresponding to a conventional spur need not be used, and trenches or the like opposing the member need not be formed. For this reason, costs do not increase, and so-called spur marks are not formed.

As the configuration of the ejection roller, as described above, any configuration which undergoes a small amount of change in shape and which generates a desired friction force with respect to a recording sheet can be used. For example, a configuration including a substrate, comprising a metal material, and a ceramic material or urethane coated on a surface of the metal substrate can be used.

The sheet supply means is arranged on an upstream side in the conveyance direction of the recording region, and the sheet ejecting means is arranged on a downstream side in the conveyance direction of the recording region. The sheet supply means and the sheet ejecting means may be arranged adjacent to the recording region.

The image forming device may further include a platen, which is arranged in the recording region formed between the sheet supply means and the sheet ejecting means and which supports the recording sheet from side thereof opposite from the surface of the sheet on which an image is formed. The image recording means may include a carriage which can be moved in a main scanning direction perpendicular to the conveyance direction of the recording sheet and a recording head, mounted on the carriage and arranged opposing the recording region, for recording an image.

In the image recording device of the present invention, the supply roller and the ejection roller are generally arranged adjacent to the image recording region. As a result, the image recording device as a whole can be made more compact.

The image recording device of the present invention may include a limiting member, which is arranged at both of width direction ends of the recording sheet and which limits displacement in a thickness direction (i.e., a direction perpendicular to the sheet surface) of the recording sheet to a certain range.

That is, displacement in the thickness direction of the recording sheet (for example, lifting of the recording sheet or the like) is limited to within the prescribed range by the limiting member. Therefore, a separation distance between the recording sheet and the image recording means can also be limited to a certain range. Consequently, high image quality image recording can be performed.

In order to prevent the recording sheet from being lifted, the image forming device may further include a member which contacts the recording surface of the recording sheet near an approximately central portion thereof in the width direction of the recording region to prevent the recording sheet from being lifted in the direction perpendicular to the surface of the recording sheet.

In the invention described above, a size of the image-recording device and a size of the recording sheet, which is an object of image recording by the image-recording device, are not particularly limited. For example, a relatively compact image-recording device can be provided for “A6” and “postcard size” recording sheets and the like. Also, the kinds of recording sheet on which images can be recorded are not particularly limited. For example, papers such as “high quality paper”, resin films such as “OHP sheets”, and the like can be used as recording sheets.

### BRIEF DESCRIPTION OF DRAWINGS

FIG. 1 is a perspective view showing an image-recording device of a first embodiment of the present invention.

FIG. 2 is a perspective view showing the image-recording device of the first embodiment of the present invention.

FIG. 3 is a sectional view showing the image-recording device of the first embodiment of the present invention.

FIG. 4 is a plan view showing the image-recording device of the first embodiment of the present invention.

FIG. 5 is an explanatory diagram showing a state in which a recording sheet is conveyed by a recording sheet supply apparatus and a recording sheet ejection apparatus in the image-recording device according to the first embodiment of the invention.

FIG. 6 is an explanatory diagram showing a state in which a recording sheet is conveyed by only the recording sheet ejection apparatus in the recording sheet supply apparatus and the recording sheet ejection apparatus in the image-recording device according to the first embodiment of the invention.

FIG. 7 is a schematic sectional view showing a recording region of the image-recording device according to the first embodiment of the present invention, cut along a transverse direction.

FIG. 8 is a graph showing a relationship between a conveying force and a spur pressure depending on a roller configuration.

FIG. 9 is a perspective view showing an image-recording device according to a second embodiment of the invention.

FIG. 10 is a perspective view showing the image-recording device according to the second embodiment of the invention.

FIG. 11 is an enlarged perspective view showing a member which prevents an image recording sheet from being lifted in the second embodiment of the invention.

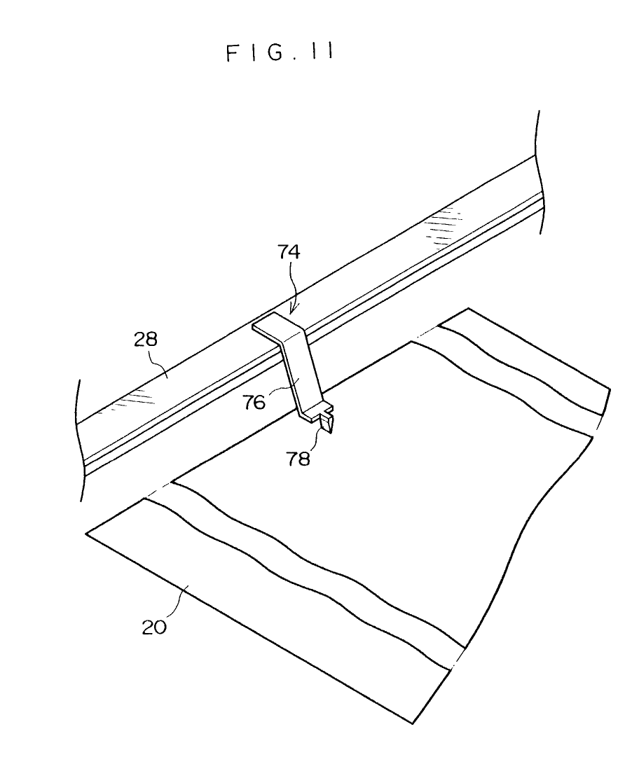

FIG. 12 is a graph showing comparison between accuracy of conveyances of the rear ends of recording sheet in the example and a comparative example.

### DESCRIPTION OF THE PREFERRED EMBODIMENTS

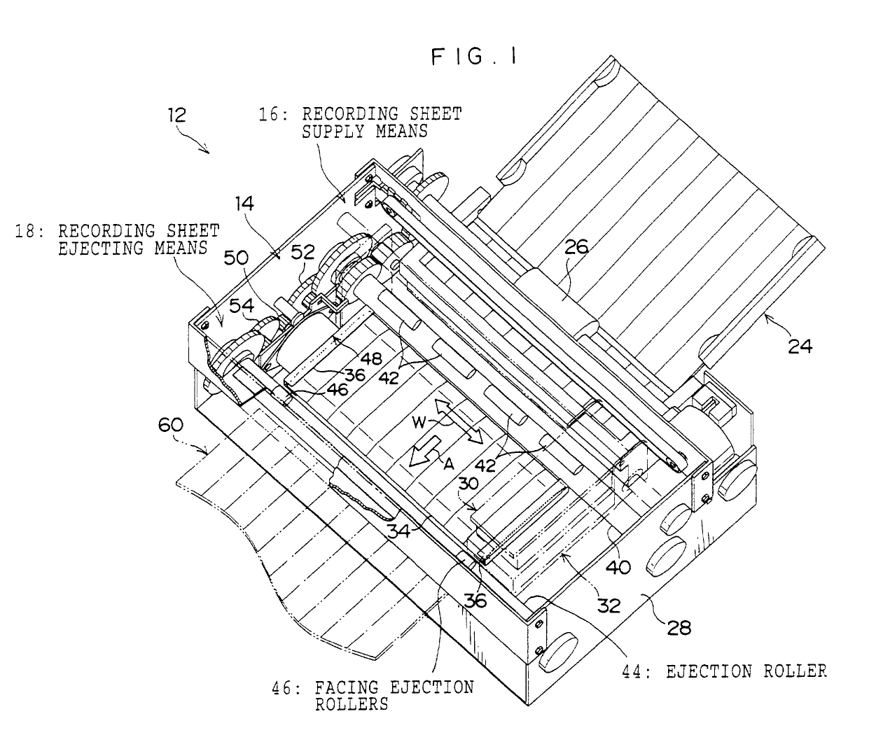

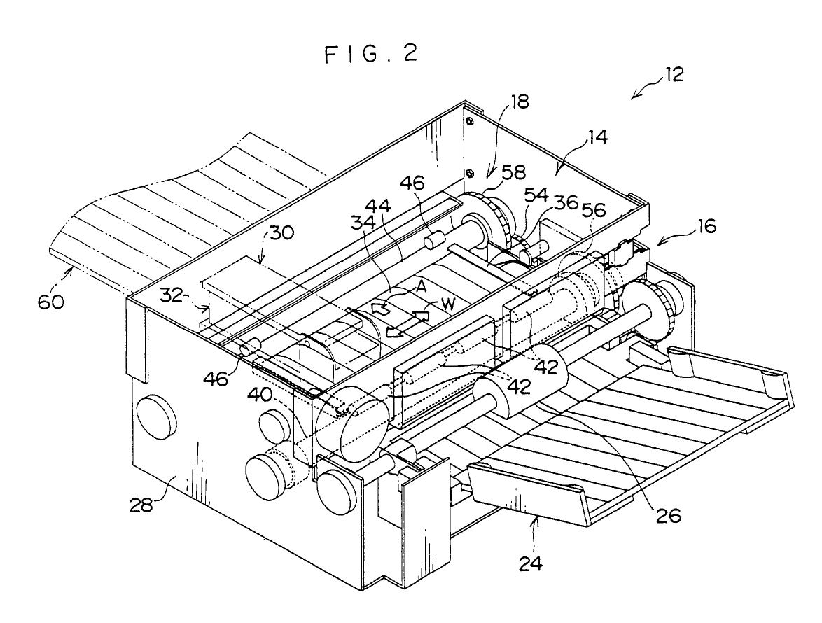

FIGS. 1 to 4 show an inkjet recording device 12, which is an image-recording device of a first embodiment of the present invention.

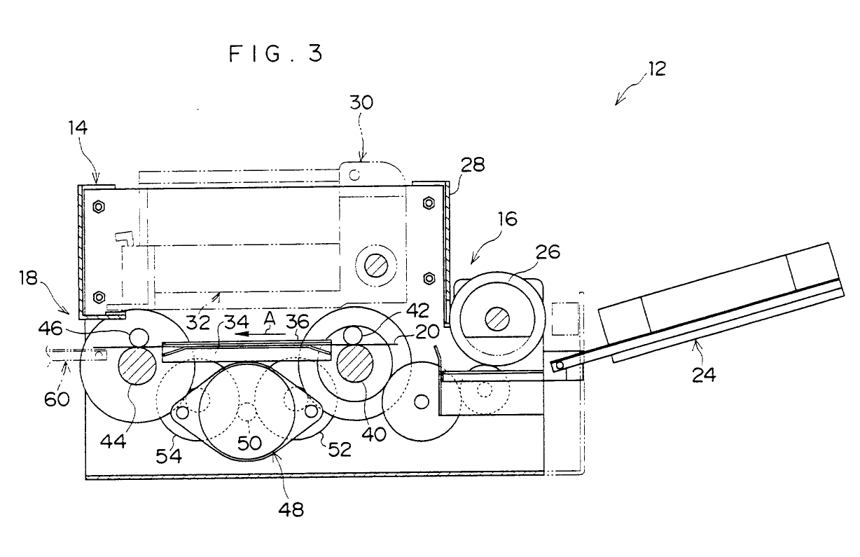

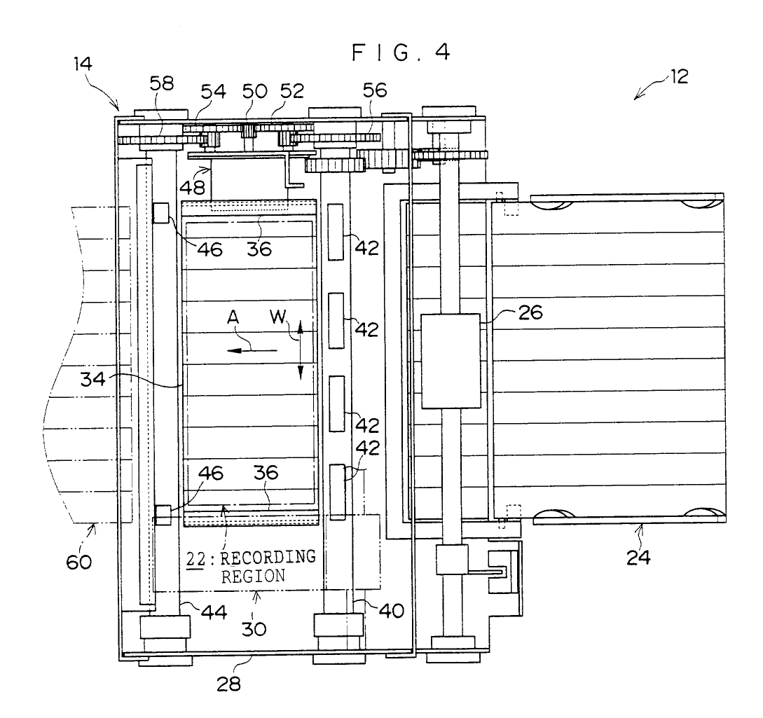

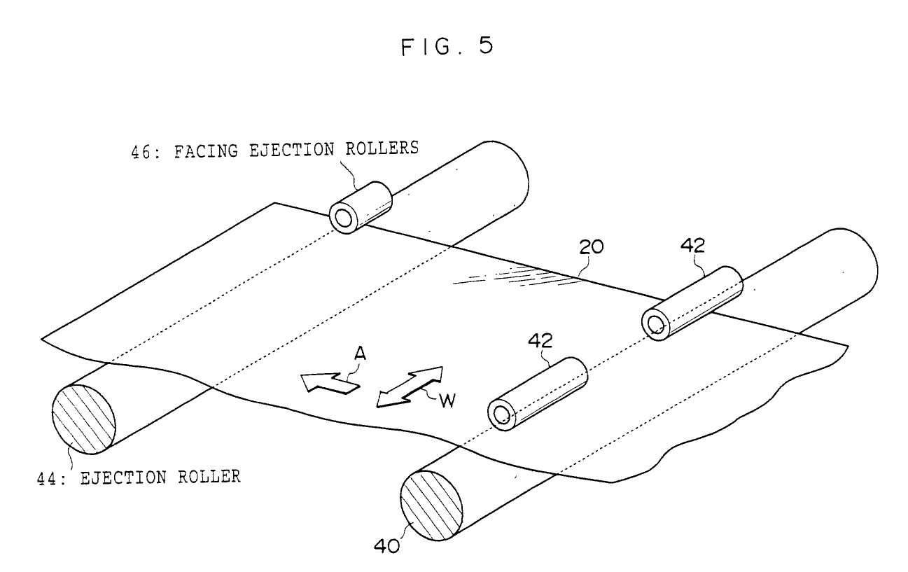

The inkjet recording device 12 includes an image-recording main body 14, a recording sheet supply apparatus 16 and a recording sheet ejection apparatus 18. The image-recording main body 14 is capable of recording images on sheets for recording 20 (see FIGS. 3, 5 nd 6), at a predetermined recording region 22 (shown in FIG. 4). The recording sheet supply apparatus 16 supplies the recording sheets 20 to the recording region 22, and the recording sheet ejection apparatus 18 discharges the recording sheets 20 from the recording region 22.

The inkjet recording device 12 further includes a supply tray 24, at which the recording sheets 20 can be stacked in a thickness direction thereof. A topmost one of the recording sheets 20 stacked at the supply tray 24 is conveyed in the direction of arrow A by a pickup roller 26 and moved toward the recording region 22. Hereinafter, the term “conveyance direction” represents the conveyance direction of the recording sheet 20, as shown by the arrow A in the drawings. Further, the term “width direction” represents a width direction of the recording sheet 20 intersecting the conveyance direction, as shown by arrow W in the drawings.

The image-recording main body 14 includes a frame member 28, which is shaped substantially like a frame. A carriage 30 is attached to the frame member 28 so as to be movable in the width direction. An inkjet recording head 32 is mounted to the carriage 30 and fixed at a predetermined attachment position. An ink discharge port of the inkjet recording head 32 opposes a surface of the recording sheet 20 in the recording region 22. The inkjet recording head 32 discharges ink drops in accordance with image information while moving in the width direction of the recording sheet 20 (the direction of the arrow W) integrally with the carriage 30. Thus, “main scanning” is carried out.

A platen 34 is fixed at a position corresponding to the recording region 22 (a region through which an ink discharge area moves, which depends on a main scanning range of the inkjet recording head 32). The recording sheet 20 is disposed on the platen 34, and thus a lower surface (rear surface) of the recording sheet 20 is supported.

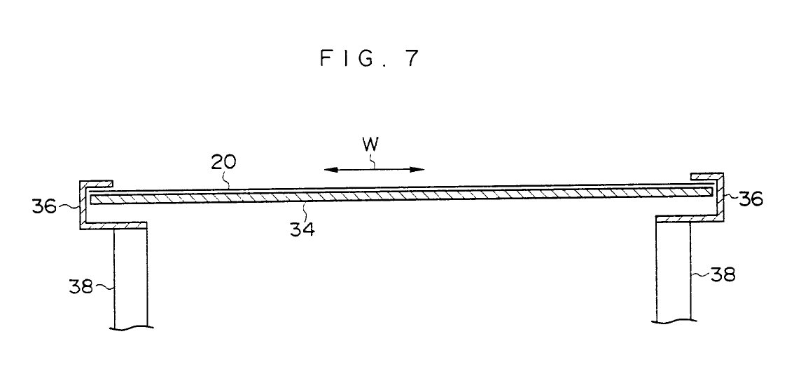

As shown in detail in FIG. 7, lifting prevention guides 36 are attached to the frame member 28 via attachment members 38. The lifting prevention guides 36 encompass both of width direction sides of the platen 34, i.e., both of side-ends (lateral ends) of the platen 34 in the conveyance direction, and oppose an upper side and both of width direction end portion sides of the recording sheet 20. Consequently, movement in the thickness direction of the recording sheet 20 (a vertical direction) is limited by the platen 34 and the lifting prevention guides 36, and flatness of the recording sheet 20 during image recording is assured. Also, movement in the width direction of the recording sheet 20 is limited by the lifting prevention guides 36. Consequently, it is to be expected that the attitude of the recording sheet 20 in the recording region 22 will be stable.

In particular, in an inkjet-type image-recording device, such as that of the present embodiment, which performs image recording by adhering ink drops to the recording sheet 20, there is a possibility that lifting of the recording sheet 20 at the platen 34 could become significant, causing a deterioration of image quality. This can be caused due to such factors as the type of the recording sheet 20, the environment during printing, and the amounts of ink being adhered. Therefore, it is preferable that the attitude of the recording sheet 20 be stabilized as in the present embodiment, at least at the recording region 22.

A supply roller 40 is disposed at an upstream side of the platen 34, adjacent to the recording region 22 and suspended along the frame member 28. An unillustrated shaft is disposed upward of the supply roller 40, and a facing supply roller 42 is attached at this shaft.

The supply roller 40 is formed to be longer than the width of the recording sheet 20. The supply roller 40 contacts the recording sheet 20 from the lower surface side thereof. A plurality of the facing supply roller 42 (four in the present embodiment) are disposed along the supply roller 40 in the width direction. The facing supply rollers 42 contact the recording sheet 20 from the upper surface side thereof. The recording sheet 20 is nipped by the supply roller 40 and the facing supply rollers 42. Thus, in this nipped state, when the supply roller 40 rotates, the recording sheet 20 is conveyed and is supplied to the recording region 22.

An ejection roller 44 is disposed at a downstream side of the platen 34, adjacent to the recording region 22 and suspended along the frame member 28. An unillustrated shaft is disposed upward of the ejection roller 44, and facing discharge rollers 46 are attached at this shaft.

Similarly to the supply roller 40, the ejection roller 44 is formed to be longer than the width of the recording sheet 20. The ejection roller 44 contacts the recording sheet 20 from the lower surface side thereof. The facing discharge rollers 46 are disposed at each of width direction end portions of the recording sheet 20. The facing discharge rollers 46 contact the recording sheet 20 from the upper surface side thereof. The recording sheet 20 is nipped by the ejection roller 44 and the facing discharge rollers 46. In this nipped state, when the ejection roller 44 rotates, the recording sheet 20 is conveyed and is ejected from the recording region 22. The facing discharge rollers 46 contact both of end vicinity portions, in the width direction (i.e., side-end vicinity portions, in the conveyance direction) of the recording sheet 20, that is, portions for which it has been specified in advance that ink will not be adhered by the inkjet recording head 32 during image recording. Accordingly, the transfer of ink which has not been dried to the facing discharge rollers 46 and re-transfer of this ink back to the recording sheet 20, which would cause a reduction in image quality, does not occur.

A driving motor 48 is disposed between the supply roller 40 and the ejection roller 44. Driving force of the driving motor 48 is transmitted from an output gear 50 of the driving motor 48 to two idle gears 52 and 54. Input gears 56 and 58 are coaxially fixed with the supply roller 40 and the ejection roller 44, respectively. The driving force is transmitted from the idle gears 52 and 54 to the input gears 56 and 58. Thus, the supply roller 40 and the ejection roller 44 are rotated.

In the inkjet recording device 12 of the present embodiment, the supply roller 40 and the ejection roller 44 each includes a rigid outer peripheral surface formed as a column or hollow cylinder. Surface treatment (surface machining) is applied thereto such that the outer peripheral surface can exhibit a predetermined frictional force with respect to the recording sheet 20. Thus, the supply roller 40 and the ejection roller 44 are surface-treated (surface-machined) rigid rollers. As a result, because a rigid body can be used as a base material of the roller, diametric accuracy and a run-out tolerance dimension are excellent compared to rubber rollers made of EPDM materials and the like, which are commonly used for conveyance of recording sheets. Also, environmental variations of the diameter are extremely small and dimensional stability is excellent.

Further, because, due to the surface treatment, the surface exhibits a predetermined frictional force with respect to the recording sheet 20, the supply roller 40 and the ejection roller 44 will not slip with respect to the recording sheet 20 during conveyance of the recording sheet 20, and conveyance can be performed with high accuracy.

As long as the above conditions are satisfied, the specific constitutions of the supply roller 40 and the ejection roller 44 are not particularly limited. For example, a metal may be used as the rigid body, and the surface of this metallic base material may be coated with ceramic or urethane. Such a roller is preferable, in that it has precise dimensions, diametric stability with respect to environmental changes, and stability in coefficient of friction.

The facing supply roller 42 and the facing discharge rollers 46 should nip the recording sheet 20 against the supply roller 40 and the ejection roller 44, respectively, with nipping forces that are suitable for reliably conveying the recording sheet 20. Also, the facing supply roller 42 and the facing discharge rollers 46 should not cause damage or the like to the surfaces of the supply roller 40 and the ejection roller 44 by local concentrations of pressure. Thus, the facing supply roller 42 and the facing discharge rollers 46 should have appropriate resiliency. As long as these conditions are satisfied, materials of the facing supply roller 42 and the facing discharge rollers 46 are not particularly limited. In the present embodiment the facing supply roller 42 and the facing discharge rollers 46 are formed of fluorine-containing elastomers, in view of assuring high reliability.

A discharge tray 60 is attached at a conveyance direction downstream side of the image-recording main body 14. Recording sheets 20 on which images have been recorded are ejected to the discharge tray 60.

Parameters of the above-described members for conveying the recording sheet 20 are decided in accordance with various conditions such as the number of recording sheets 20 in a stack as determined by specifications of the inkjet recording device 12, types of the recording sheets 20, anticipated environments (temperature and humidity) and the like, so that the conveyance performance of the members is affected as least as possible by change/variations of such conditions.

Now, operation of the inkjet recording device 12 of the present embodiment will be described.

The topmost of the recording sheets 20 stacked on the supply tray 24 is conveyed in the direction of the arrow A by the pickup roller 26. Then, the recording sheet 20 is nipped by the supply roller 40 and the facing supply roller 42, from the front end side of the recording sheet 20, and the recording sheet 20 is conveyed further by rotation of the supply roller 40.

When the recording sheet 20 reaches the recording region 22, conveyance of the recording sheet 20 is temporarily halted. Then, the carriage 30 moves in the width direction (the direction of the arrow W) and, at the same time, the inkjet recording head 32 discharges ink drops to the upper surface of the recording sheet 20 from the unillustrated ink discharge port in accordance with image information. Thus, main scanning is carried out. When main scanning has been completed for one line, the supply roller 40 rotates such that the recording sheet 20 is conveyed by an amount of precisely one line width (a distance in the conveyance direction). Hence, the recording sheet 20 is conveyed and sub-scanning is carried out.

In this manner, main scanning and sub-scanning are alternately repeated, and a desired image is recorded on the upper surface of the recording sheet 20.

During image recording (or, depending on the relation between the size of the image and the size of the recording sheet 20, after image recording has finished), the recording sheet 20 is nipped by the ejection roller 44 and the facing discharge rollers 46, from the front end side of the recording sheet 20, and the recording sheet 20 is conveyed further by rotation of the ejection roller 44. That is, the recording sheet 20 will be nipped at both the front end side and rear end side thereof, as shown in FIG. 5, until a portion nipped by the supply roller 40 and the facing supply roller 42 at the rear end of the recording sheet 20 is released.

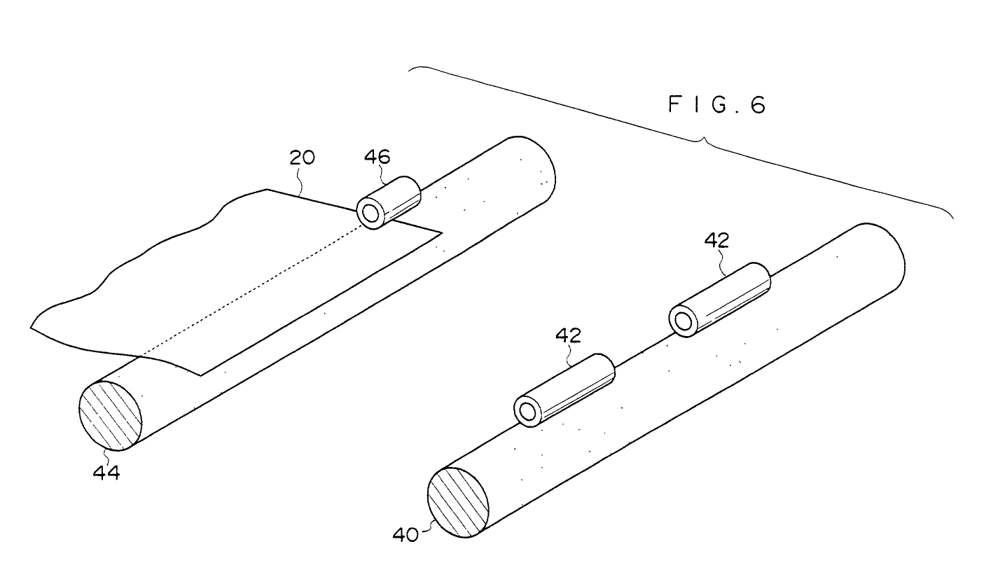

Then, as shown in FIG. 6, when the portion nipped by the supply roller 40 and the facing supply roller 42 at the rear end of the recording sheet 20 has been released, the recording sheet 20 is nipped and conveyed only by the ejection roller 44 and the facing discharge rollers 46. While the image is being recorded on the recording sheet 20, the ejection roller 44 repeatedly halts and rotates in accordance with single line widths (the distance in the conveyance direction), in the same manner as the supply roller 40. When image recording has finished, the ejection roller 44 rotates continuously and the recording sheet 20 is ejected in a short time.

In general, it is understood from experiments and simulations that main factors for determining image quality (print performance) at a portion near the rear end of the recording sheet are a diametric accuracy and a run-out tolerance dimension of the roller for ejecting the recording sheet from the recording region (the ejection roller 44 in this embodiment). More specifically, in image recording of the portion near the rear end of the recording sheet, the recording sheet is conveyed by only the conveying force of the roller on the ejection side (the ejection roller 44) as described above. For this reason, the diametric accuracy and the run-out tolerance dimension of the roller directly influence the accuracy of conveyance of the recording sheet. In particular, when an interval between the supply roller 40 and the ejection roller 44 is long (for example, the interval may be about 50 mm or more), the accuracy of conveyance of the ejection roller influences the image recording precision at the portion near the rear end of the recording sheet 20 over a relatively large area of the portion near the rear end of the recording sheet 20. In addition, it is apparent that precise conveyance of the recording sheet cannot be realized with a roller produced with a normal rubber material. Furthermore, since the roller comprising a rubber material decreases in diameter because the rubber constricts in a low-temperature environment, a conveyance distance of the recording sheet is shorter than a set value, and image deterioration (so-called black line) occurs.

In the inkjet recording device 12 according to this embodiment, the supply roller 40 for supplying the recording sheet 20 to the recording region 22 and the ejection roller 44 for ejecting the recording sheet 20 from the recording region 22 each comprise a rigid roller subjected to surface treatment. Therefore, not only the inkjet recording device 12 is in a low-temperature environment, but when a factor other than the low-temperature environment (variation in environment other than a variation in temperature or an external force) acts on the inkjet recording device 12, the diametric accuracy and the run-out tolerance dimension of the roller are excellent, and a variation in outside dimension (outside diameter) caused by the environment is very small. Furthermore, a desired friction force is generated with respect to the recording sheet 20 by surface treatment to prevent slipping. For this reason, the recording sheet 20 can be conveyed with high accuracy.

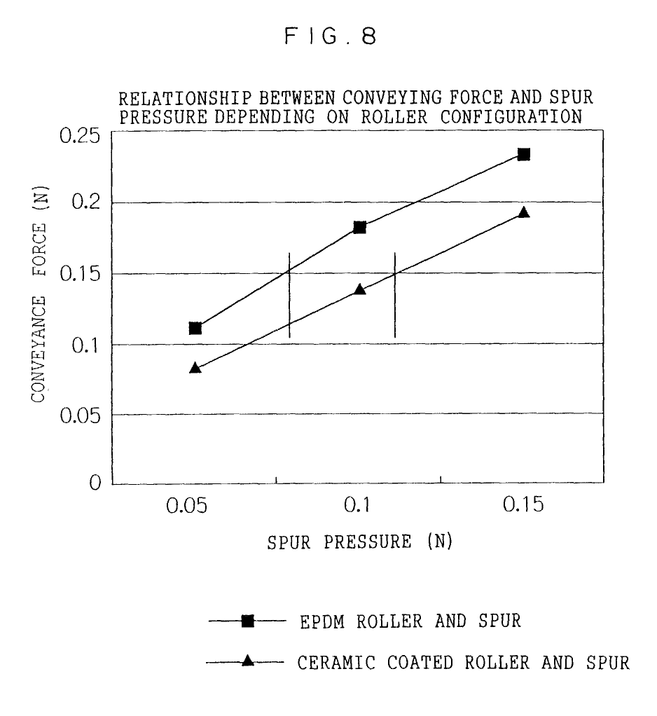

When spurs (star wheels), which are commonly employed in general inkjet recording devices, are employed as the facing ejection rollers 46, a problem may occur with respect to a conveying force (will be described later), and actually it is not preferable that the spur is used. FIG. 8 is a graph showing relationships between conveying forces and spur pressures obtained when a spur and a ceramic coated roller (metal roller coated with ceramic) are respectively employed as the facing ejection rollers 46 and the ejection roller 44, and when a spur and an EPDM roller are respectively employed as the facing ejection rollers 46 and the ejection roller 44.

As is apparent from this graph, when the ceramic coated roller is used, in order to obtain the same conveying force that is obtained when an EPDM roller is employed, a pressure which is higher than that applied to an EPDM roller must be applied to the spur. For example, when the ceramic coated roller is used, in order to obtain 0.15 N as a conveying force, the device must be set such that a pressure, which is about 1.5 times greater than a pressure applied when the EPDM roller is used, is applied to the spur.

Therefore, in the configuration in which metal rollers subjected to surface treatment are used as the supply roller 40 and the ejection roller 44 and spurs are used as the facing ejection rollers 46, in order to obtain a sufficient conveying force, for example, the number of spurs must be increased or trenches must be formed in the peripheral surfaces of the rigid rollers, thereby increasing costs. In contrast to this, as in this embodiment, when the facing supply rollers 42 and the facing ejection rollers 46 comprise a material having appropriate elasticity, low costs are achieved, and an appropriate nipping force is generated between the supply roller 40 and the ejection roller 44 to reliably convey the recording sheet 20. In particular, since the facing ejection rollers 46 are arranged at both of width direction end portions of the recording sheet 20, even if the number of rollers is small, and even if a nipped portion is narrow, the recording sheet 20 can be reliably conveyed with high accuracy by employing the above configuration. In addition, since a localized load is not applied to the surfaces of the supply roller 40 and the ejection roller 44, the supply roller 40 and the ejection roller 44 are not damaged.

In the inkjet recording device 12 according to this embodiment, both the supply roller 40 and the ejection roller 44 comprise rigid rollers subjected to surface treatment. However, in order to improve accuracy of conveyance in image recording of a portion near the rear end of the recording sheet 20, a configuration may be used in which only the ejection roller 44 comprises a surface-treated rigid roller.

Also, although the positions of the supply roller 40 and the ejection roller 44 are not particularly limited as long as the recording sheet 20 is reliably conveyed, by disposing the supply roller 40 and the ejection roller 44 adjacent to the recording region 22, it can be expected that the inkjet recording device 12 will as a whole be more compact.

Size and the like of the recording sheet 20, which is the object of image recording, are not particularly limited for any of the inkjet recording devices of these embodiments. However, bearing in mind that the facing discharge rollers 46 nip the recording sheet 20 only at both end vicinity portions in the width direction thereof, if the object of recording is, for example, A6 size or postcard size, the object of recording is preferably conveyed with a short side direction thereof set along the width direction. This is preferable because lifting of the recording sheet at a width direction central portion thereof can be more reliably prevented.

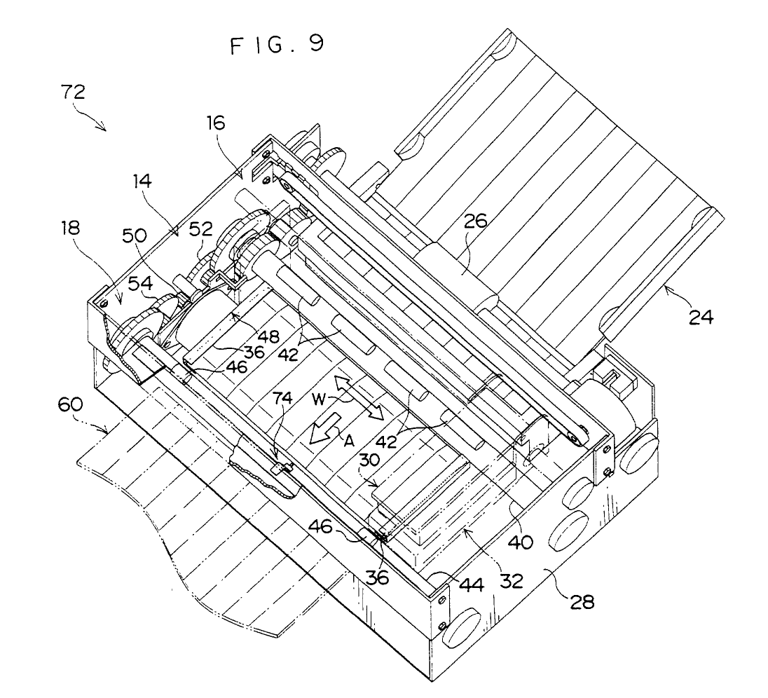

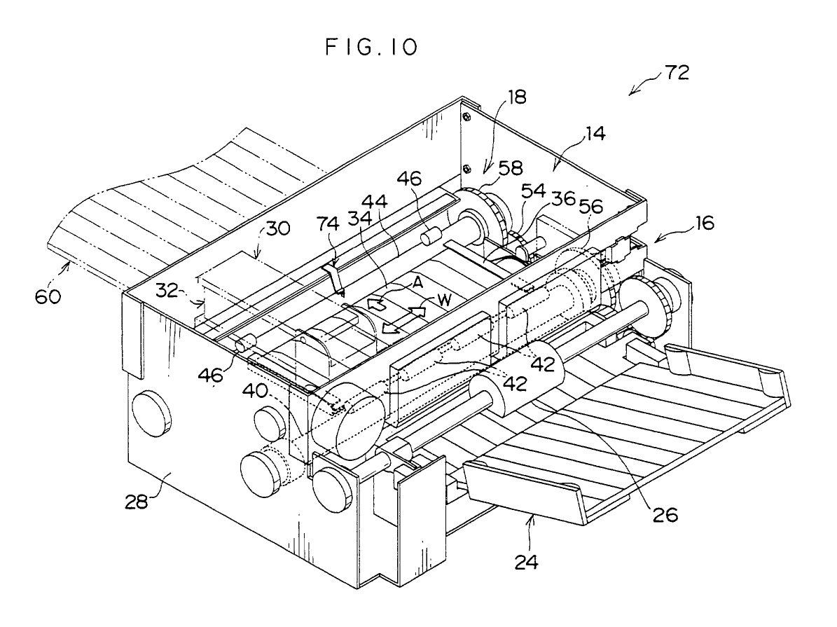

Naturally, a recording sheet having a width larger than that of the above recording sheet may be used as an object. In this case, for example, the configuration of an inkjet recording device 72 according to the second embodiment shown in FIGS. 9 and 10 can be employed.

This inkjet recording device 72 has substantially the same configuration as that of the inkjet recording device 12 according to the first embodiment. However, the inkjet recording device 72 is different from the inkjet recording device 12 only in that a lift prevention member 74 is further provided.

The lift prevention member 74 has one end thereof fixed to the frame member 28. The other end thereof is constituted by an arm 76 located near the upper surface of the recording sheet 20 in the recording region 22 and a contact piece 78 formed at an end of the arm 76. A lower end of the contact piece 78 is disposed at the center of the recording sheet 20 in the width direction thereof, and is in contact with the upper surface of the recording sheet 20. In this manner, upward movement of the recording sheet 20 is regulated by the lift prevention member 74 at the center of the recording sheet 20 in the width direction thereof. For this reason, even if the recording sheet 20 has a size which is larger than, for example, that of an A6 size recording sheet or a postcard size recording sheet, a predetermined distance is maintained between the recording sheet 20 and the inkjet recording head 32, so that a high-quality image can be recorded.

The thickness of the lower end portion of the contact piece 78, i.e., the length of a portion of the contact piece 78 that contacts the recording sheet 20 in the width direction is set to be such a value (e.g., 0.2 mm or less, preferably, 0.1 mm or less) that image quality is not substantially affected even though undried ink on the recording sheet 20 is transferred to the contact piece 78 and re-transferred to the recording sheet 20. In this manner, image quality can be prevented from being deteriorated by re-transfer of ink, and an image of higher quality can be recorded.

In place of the contact piece 78, a spur, which is generally used, may be employed. In this case, the spur does not operate to convey the recording sheet 20, but rather operates to prevent the recording sheet 20 from being lifted. Therefore, the relatively high spur pressure required to convey the recording sheet 20 is not required, and the spur may be in light contact with the recording sheet 20. For this reason, a member for providing support against pressure from the spur need not be disposed on the lower surface side of the recording sheet 20, and the structure can be simplified.

The embodiments described above are examples of image-recording devices of the present invention. Examples of inkjet recording devices that record images on recording sheets (recording paper) by inkjet methods have been explained. Image-recording devices of the present invention are not limited to devices that use such inkjet methods. For example, the present invention may also be applied to devices that use electrophotographic methods. In such a case, a structure applicable to electrophotography may be employed for the main body of the recording device.

### EXAMPLE

The present invention will be described below in detail with reference to an example. The invention, however, is not limited to the following example.

In this example, the inkjet recording device 12 according to the first embodiment is used to record an image on the recording sheet 20 under the following conditions, and sensual evaluation of the image quality of an image obtained at a portion near the rear end of the recording sheet 20 (a portion where an image is recorded when the recording sheet 20 is conveyed by only the ejection roller 44) is performed. Accuracy of conveyance at the rear end of the recording sheet 20 is evaluated.

Type of recording sheet 20: Postcard

Size of recording sheet 20: 148 mm in length×100 mm in width×0.2 mm in thickness

Conveyance distance (theoretical value) of recording sheet 20 per sub-scanning of inkjet recording device 12: 5.08 mm

Material of supply roller 40: ceramic coated roller (metal shaft)

Diameter of supply roller 40: φ9.7

Material of facing supply roller 42: fluorine-contained elastomer

Diameter of facing supply roller 42: φ1.5

Material and diameter of ejection roller 44: same as those of supply roller 40

Material and diameter of facing ejection rollers 46: same as those of facing supply roller 42

As a comparative example, evaluation of an inkjet recording device, which employed a conventional EPDM rubber roller instead of the ejection roller 44 of this embodiment, is performed in the same manner as described above.

The conveyance of the recording sheet 20 is continuously repeated several tens of times under the above-described conditions, and variation in conveyance distance is evaluated. For this evaluation, in general, it is understood that an image having sufficiently high quality is obtained when the width of the variation in the sensual evaluation for image quality is 0.05 mm or less. For this reason, the target value of the width of the variation is set at 0.05 mm.

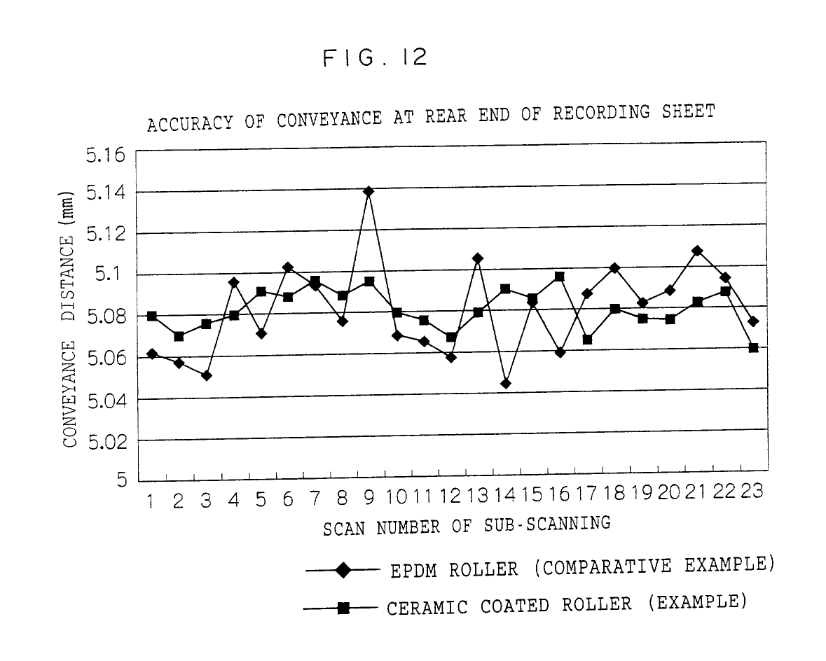

The results are shown in FIG. 12. As is apparent from this graph, in the inkjet recording device which employed the conventional EPDM rubber roller, the width of the variation in conveyance distance is about 0.1 mm. In contrast to this, in the inkjet recording device 12 according to this embodiment, the width of the variation in conveyance distance is about 0.04 mm and achieves the target value. Thus, image quality of an image recorded by the inkjet recording device 12 according to this embodiment is better than that of the comparative example.

With respect to a portion other than the portion near the rear end of the recording sheet 20, i.e., a portion where an image is recorded when the recording sheet 20 is conveyed by both the supply roller 40 and the ejection roller 44, the same evaluation as described above is performed. As a result, the width of a variation in accuracy of conveyance of the recording sheet 20 is about 0.025 mm. Therefore, a result that is better than that obtained when the recording sheet 20 is conveyed by only the ejection roller 44 is obtained.

To summarize, with the present invention, conveyance amounts are consistently maintained throughout the whole area of a recording sheet by the constitutions described above. Thus, images of high image quality can be recorded without incurring an increase in costs.

What is claimed is:

1. A device for recording an image on a recording sheet, the device comprising:
image recording means including a recording region for recording an image on a recording sheet conveyed to the recording region;
sheet supply means for supplying the recording sheet to the recording region; and
sheet ejecting means for ejecting the recording sheet from the recording region, wherein at least one of the sheet supply means and the sheet ejecting means includes, a first roller arranged for contacting the recording sheet on a surface on which an image is formed by the image recording means, and a second roller arranged in opposition to the first roller and with the rollers nipping the recording sheet when the recording sheet passes between the rollers, and the second roller comprising a rigid body and a surface treated to generate a friction force between the second roller and the recording sheet when passing between the rollers for conveyance of the recording sheet.

2. The device of claim 1, wherein the first roller is arranged to be in contact with said surface of the recording sheet at least near both width direction end portions of the recording sheet.

3. The device of claim 1, wherein the rigid body substantially consists of a metal substrate, and has a surface which is coated with a ceramic material.

4. The device of claim 1, wherein the rigid body comprises a metal substrate, and said surface comprises an urethane coating.

5. The device of claim 1, wherein the first roller comprises a material containing a fluorine-contained elastomer.

6. The device of claim 1, wherein relative to conveyance direction the sheet supply means is arranged on the upstream side of the recording region, and the sheet ejecting means is arranged on the downstream side of the recording region.

7. The device of claim 1, wherein the sheet supply means and the sheet ejecting means are arranged adjacent to the recording region.

8. The device of claim 1, further comprising limiting members, arranged near both width direction end portions of the recording sheet at least when conveyed in the recording region for regulating displacement of the sheet in a direction perpendicular to the recording sheet surface.

9. The device of claim 1, further comprising a platen arranged between the sheet supply means and the sheet ejecting means and which supports the sheet when conveyed therebetween.

10. The device of claim 1, wherein the image recording means comprises a carriage which movable in a direction perpendicular to the conveyance direction along the recording sheet surface and a recording head mounted on the carriage for recording the image on the recording sheet in the recording region.

11. The device of claim 1, further comprising a member which contacts the recording sheet surface near an approximately central portion in the width direction of the recording region at least during an image recording, to prevent the recording sheet from being lifted in the direction perpendicular to the recording sheet surface.

12. The device of claim 1, wherein the sheet ejecting means includes said rollers.

13. The device of claim 12, wherein the first roller is arranged to be in contact with said surface of the recording sheet at least near both width direction end portions of the recording sheet.

14. The device of claim 12, wherein the rigid body substantially consists of a metal substrate, and has a surface which is coated with a ceramic material.

15. The device of claim 12, wherein the rigid body comprises a metal substrate, and said surface comprises an urethane coating.

16. The device of claim 12, wherein the first roller comprises a material containing a fluorine-contained elastomer.

17. The device of claim 12, wherein the sheet supply means and the sheet ejecting means are arranged adjacent to the recording region.

18. The device of claim 12, further comprising limiting members, arranged near both width direction end portions of the recording sheet at least when conveyed in the recording region for regulating displacement of the sheet in a direction perpendicular to the recording sheet surface.

19. The device of claim 12, further comprising a platen arranged between the sheet supply means and the sheet ejecting means and which supports the sheet when conveyed therebetween.

20. The device of claim 12, wherein the image recording means comprises a carriage which movable in a direction perpendicular to the conveyance direction along the recording sheet surface and a recording head mounted on the carriage for recording the image on the recording sheet in the recording region.
